(19) United States
(12) Patent Application Publication
(10) Pub. No.: US 2023/0319009 A1
(43) Pub. Date: Oct. 5, 2023

(54) SINGLE MAC ADDRESS FOR NETWORK DEVICES

(71) Applicant: Hewlett-Packard Development Company, L.P., Spring, TX (US)

(72) Inventors: ISAAC LAGNADO, SPRING, TX (US); STEVEN PETIT, SPRING, TX (US)

(73) Assignee: Hewlett-Packard Development Company, L.P., Spring, TX (US)

(21) Appl. No.: 18/042,976

(22) PCT Filed: Oct. 19, 2020
(86) PCT No.: PCT/US2020/056371

§ 371 Date: Feb. 24, 2023

(51) Int. Cl. H04L 61/5038

(52) U.S. Cl. CPC H04L 61/5038; H04L 2101/622

(57) ABSTRACT

Examples of electronic devices are described herein. In some examples, an electronic device includes a first network device and a second network device. In some examples, the electronic device includes a processor to assign a single media access control (MAC) address to the first network device and the second network device. In some examples, the processor is to determine that the first network device is connected to a network using the single MAC address. In some examples, the processor is to disable the second network device in response to determining that the first network device is connected to the network.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

Various examples will be described below by referring to the following figures.

FIG. 1 is a block diagram illustrating an example of an electronic device to use a single media access control (MAC) address for network devices;

FIG. 2 is a block diagram illustrating an example of a computer-readable medium encoded with instructions to use a single MAC address for network devices in an electronic device;

FIG. 3 is a flow diagram illustrating an example method for using a single MAC address for network devices;

FIG. 4 is a flow diagram illustrating another example method for using a single MAC address for network devices;

FIG. 5 is a flow diagram illustrating another example method for using a single MAC address for network devices;

FIG. 6 is a flow diagram illustrating another example method for using a single MAC address for network devices; and

FIG. 7 is a flow diagram illustrating yet another example method for using a single MAC address for network devices.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples in accordance with the description; however, the description is not limited to the examples provided in the drawings.

### DETAILED DESCRIPTION

An electronic device may be a device that includes electronic circuitry. For instance, an electronic device may include integrated circuitry (e.g., transistors, digital logic, semiconductor technology, etc.). Examples of electronic devices include computing devices, laptop computers, desktop computers, smartphones, tablet devices, wireless communication devices, game consoles, game controllers, smart appliances, printing devices, vehicles with electronic components, aircraft, drones, robots, smart appliances, etc.

In some examples, an electronic device may include multiple network devices. As used herein, a network device includes circuitry (e.g., hardware) and instructions (e.g., software) for communicating with other devices on a network. Examples of network devices include wired communication devices (e.g., Ethernet adapters) and wireless communication devices (e.g., Wi-Fi adapters, Bluetooth (BT) adapters).

In some examples, each network device may have a unique media access control (MAC) address. For example, a network device may include a unique MAC address that is recorded at the factory during the manufacture of the network device. The unique MAC address may be an original MAC address. The original MAC addresses may be unique such that networking protocols uniquely identify where packets are to be routed on a networking infrastructure.

In some examples, organizations may utilize the MAC address as a security mechanism. For example, an electronic device may be registered on a network using a MAC address of the network device used by the electronic device for network communications. A network may disallow un-registered or unknown MAC addresses to be authorized on the network. In some examples, an un-registered MAC address may not be able to receive an internet protocol (IP) address. In other examples, the port on a network switch associated with an un-registered MAC address may not be able to become active, thereby blocking unauthorized users from gaining access to network resources.

In some examples, electronic devices may be capable of accessing the network in multiple ways. For example, an electronic device may include multiple network devices. In an example, an electronic device may use an Ethernet adapter, a Wi-Fi adapter and/or the Ethernet adapter of a dock for the electronic device. In this example, this means that an information technology (IT) administrator may manage up to three different MAC addresses for every electronic device deployed on a network. This adds extra complexity to network management due to the number of MAC addresses used by the electronic devices.

In other examples, a MAC address may be associated with a particular IP address lease. If an electronic device switches frequently between different network devices (e.g., Ethernet and Wi-Fi), then the IP address lease for the electronic device will also be reserved. This may cause more difficulty for the IT administrator as more than one IP address lease will be reserved for each device.

In some examples described herein, a single MAC address may be shared between multiple network devices associated with a single electronic device (also referred to as a host device). In some examples, multiple network devices of the electronic device may be programmed with a single MAC address. For example, if a user chooses to activate the single MAC address, then the multiple network devices of the electronic device may be programmed with a single MAC address.

To avoid multiple network devices accessing the network with the same MAC address, the electronic device may monitor whether a network device is connected to the network using the single MAC address. In some examples, the electronic device may allow a single network device to become active at any single point in time. In this case, if the electronic device programs the multiple network devices with the same MAC address, then the electronic device may monitor when each network device is connected to a network. Once a network device is connected to the network, then the electronic device may disable the other network devices to ensure that a single network device using the single MAC address is active on the network.

In other examples, the electronic device may assign a single MAC address to multiple network devices. The electronic device may then enable the multiple network devices to connect to the network. Once a network device is connected to the network, the electronic device may restore the original MAC addresses to the other network devices.

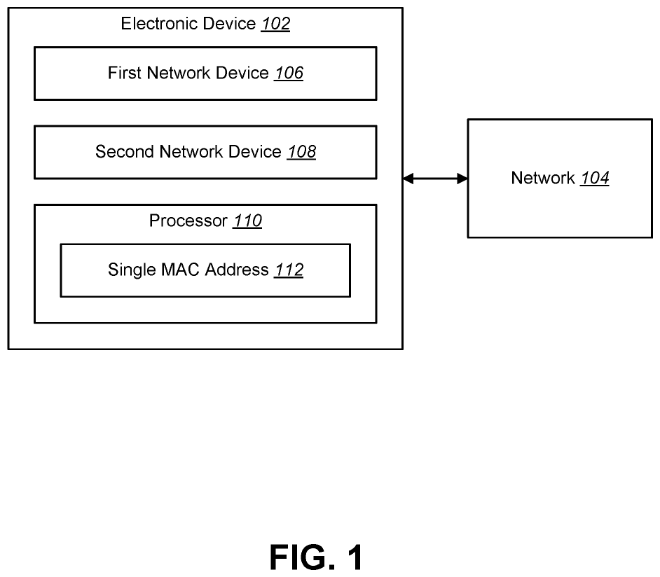

FIG. 1 is a block diagram illustrating an example of an electronic device 102 that may be utilized for a basic input/output system (BIOS) safe mode. Examples of the electronic device 102 may include computing devices, laptop computers, desktop computers, tablet devices, cellular phones, smartphones, wireless communication devices, game consoles, gaming controllers, smart appliances, printing devices, vehicles with electronic components, aircraft, drones, robots, smart appliances, etc.

In some examples, the electronic device 102 may include a processor 110. The processor 110 may be any of a microcontroller (e.g., embedded controller), a central processing unit (CPU), a semiconductor-based microprocessor, graphics processing unit (GPU), field-programmable gate array (FPGA), an application-specific integrated circuit (ASIC), a circuit, a chipset, and/or other hardware device suitable for retrieval and execution of instructions stored in a memory. The processor 110 may fetch, decode, and/or execute instructions stored in memory (not shown). While a single processor 110 is shown in FIG. 1, in other examples, the processor 110 may include multiple processors (e.g., a CPU and a GPU).

The memory may be any electronic, magnetic, optical, and/or other physical storage device that contains or stores electronic information (e.g., instructions and/or data). The memory may be, for example, Random Access Memory (RAM), Electrically Erasable Programmable Read-Only Memory (EEPROM), Dynamic Random Access Memory (DRAM), Synchronous DRAM (SDRAM), magnetoresistive random-access memory (MRAM), phase change RAM (PCRAM), non-volatile random-access memory (NVRAM), memristor, flash memory, a storage device, and/or an optical disc, etc. In some examples, the memory may be a non-transitory tangible computer-readable storage medium, where the term “non-transitory” does not encompass transitory propagating signals. The processor 110 may be in electronic communication with the memory. In some examples, a processor 110 and/or memory of the electronic device 102 may be combined with or separate from a processor (e.g., CPU) and/or memory of a host device.

In some examples of the electronic devices described herein, the electronic device 102 may include a Basic Input/Output System (BIOS). As used herein, a basic input/output system (BIOS) refers to hardware or hardware and instructions to initialize, control, or operate an electronic device 102 prior to execution of an operating system (OS) of the electronic device 102. Instructions included within a BIOS may be software, firmware, microcode, or other programming that defines or controls functionality or operation of a BIOS. In one example, a BIOS may be implemented using instructions, such as platform firmware of an electronic device 102, executable by a processor. A BIOS may operate or execute prior to the execution of the OS of an electronic device 102. A BIOS may initialize, control, or operate components such as hardware components of an electronic device 102 and may load or boot the OS of the electronic device 102.

In some examples, a BIOS may provide or establish an interface between hardware devices or platform firmware of the electronic device 102 and an OS of the electronic device 102, via which the OS of the electronic device 102 may control or operate hardware devices or platform firmware of the electronic device 102. In some examples, a BIOS may implement the Unified Extensible Firmware Interface (UEFI) specification or another specification or standard for initializing, controlling, or operating an electronic device 102.

In some examples, the processor 110 may be included as part of the BIOS of the electronic device 102. In this case, the BIOS, using processor 110, may implement the methods described herein for a single MAC address 112. In other examples, the processor 110 may be used to execute the OS of the electronic device 102. In these examples, the OS, using the processor 110, may implement the methods described herein for a single MAC address 112.

In some examples, the electronic device 102 may include multiple network devices to communicate on a network 104. For example, the electronic device 102 may include a first network device 106 and a second network device 108. The first network device 106 and second network device 108 may be hardware to connect the electronic device 102 to a network 104. In some examples, the network devices may be each be a transceiver. In other examples, the network devices may be implemented in a chipset of the electronic device 102. Some examples of types of network communication performed by the network devices include Ethernet, Wi-Fi, Bluetooth (BT), etc.

It should be noted that while two network devices (e.g., the first network device 106 and the second network device 108) are shown in FIG. 1, in other examples, the electronic device 102 may include more than two network devices. For example, the electronic device 102 may include an Ethernet adapter and a Wi-Fi adapter. The electronic device 102 may also connect to a dock that also includes an Ethernet adapter. In this example, the electronic device 102 includes three network devices that may be used to connect to the network 104. In other examples, the electronic device 102 may include an Ethernet adapter, a Wi-Fi adapter and a BT adapter that are each capable of communications on a network 104.

The first network device 106 and the second network device 108 may each have a unique MAC address. For example, each of the network devices may include an original MAC address as programmed during manufacturing of the network devices. Therefore, the first network device 106 may include a first original MAC address and the second network device 108 may include a second original MAC address.

As used herein, a MAC address is an identifier assigned to a network device that is used by the network 104 for network communications. For example, packets may be routed to and from a network device using the MAC address of the network device. In some other examples, the MAC address may also be used to register an electronic device on a network 104. For instance, the network 104 may authenticate that an electronic device 102 is authorized to access network resources based on the MAC address of the network device used to connect the electronic device 102 to the network 104.

In some examples, the electronic device 102 may use a single MAC address 112 for the multiple network devices on the electronic device 102. The single MAC address 112 may be shared by the network devices on the electronic device 102 and network devices included in accessories (e.g., a dock) to which the electronic device 102 is connected.

In some examples, the single MAC address 112 may be stored in memory of the electronic device 102. For example, the processor 110 may store the single MAC address 112 that is to be applied to the first network device 106 and the second network device 108 in memory. In this manner, the processor 110 may recall the single MAC address 112.

In some examples, the processor 110 may generate the single MAC address 112. For example, the processor 110 may use a random number generator or other process to generate the single MAC address 112.

In other examples, the electronic device 102 may be programmed with the single MAC address 112 that differs from the original (e.g., factory programmed) MAC address of the first network device 106 and the second network device 108. For example, the single MAC address 112 may be programmed into the electronic device 102 during manufacturing of the electronic device 102. In another example, the single MAC address 112 may be downloaded by the electronic device 102 and stored in memory. In these examples, the single MAC address 112 may be referred to as a host MAC address or system MAC address.

In yet other examples, the processor 110 may use one of the original MAC addresses of the network devices as the single MAC address 112. For example, the processor 110 may select the single MAC address 112 from one of a factory programmed MAC address for the first network device 106 or a factory programmed MAC address for the second network device 108.

The processor 110 may assign the single MAC address 112 to the first network device 106 and the second network device 108. For example, the processor 110 may override the original MAC address of a network device using the single MAC address 112. In some examples, the single MAC address 112 assigned to a network device may differ from the factory programmed MAC address for the network device. For example, the single MAC address 112 may override the original MAC address that is programmed into the first network device 106 and/or the second network device 108.

In some examples, the processor 110 may assign the single MAC address 112 to the first network device 106 and the second network device 108 in response to receiving a command to enable the single MAC address 112. In some examples, a user may choose to enable the single MAC address 112. For example, a user may activate the single MAC address 112 in a setting with the BIOS and/or the OS. Upon receiving the user input, the BIOS and/or the OS may send a command to the processor 110 to assign the single MAC address 112 to the first network device 106 and the second network device 108.

Upon assigning the single MAC address 112 to the first network device 106 and the second network device 108, the processor 110 may ensure that a single network device becomes active on the network 104 at any single point in time. For example, if the processor 110 programs the first network device 106 and the second network device 108 with the same MAC address (e.g., the single MAC address 112), the processor 110 may monitor whether a network device is connected to the network 104.

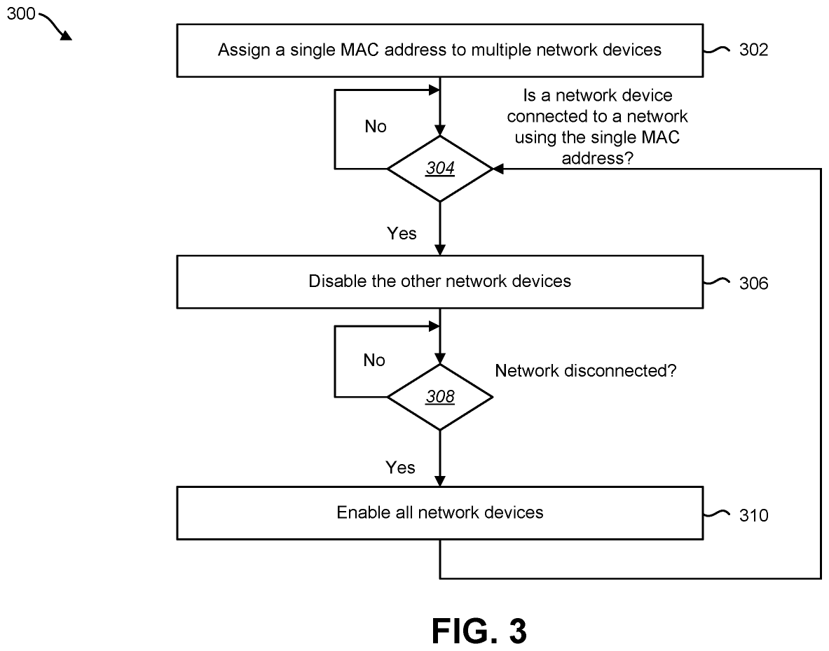

Different examples of monitoring the network devices to ensure that a single network device uses the single MAC address 112 are described herein. In some examples, the processor 110 may determine that a network device (e.g., the first network device 106) is connected to a network 104 using the single MAC address 112. The processor 110 may then disable the other network devices (e.g., the second network device 108) to ensure that a single network device uses the single MAC address 112 to connect to network 104. An example of this approach is described in FIG. 3.

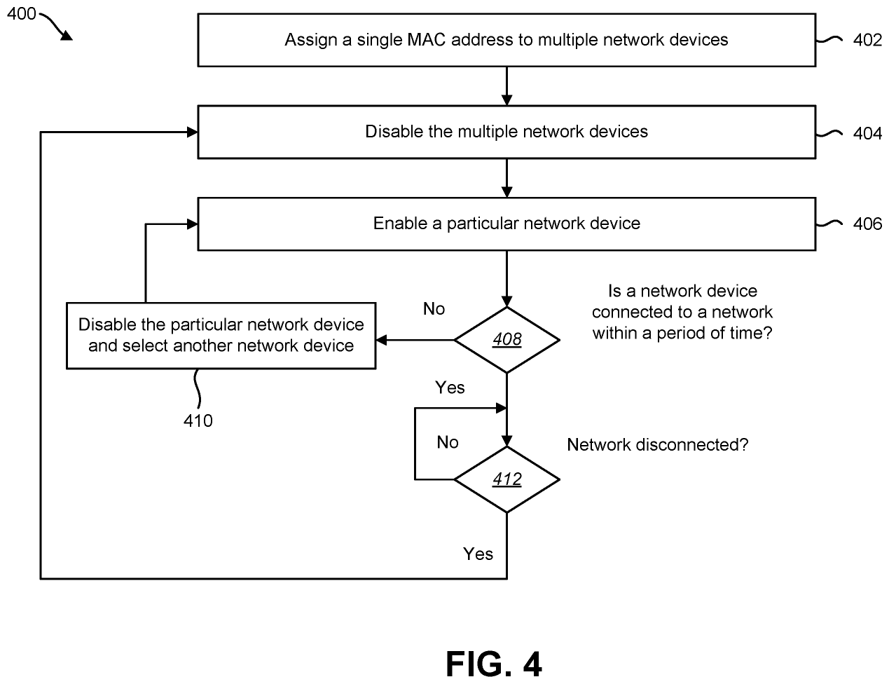

In yet other examples, the processor 110 may perform a round-robin approach to determine whether a network device is connected to the network 104. This round-robin approach may avoid a race condition for network devices competing to connect to the network 104. For example, the processor 110 may assign the single MAC address 112 to the multiple network devices (e.g., the first network device 106 and the second network device 108). The processor 110 may then disable the multiple network devices (e.g., the first network device 106 and the second network device 108) from connecting to the network 104. The processor 110 may then enable the multiple devices one at a time to determine if a network device is connected to the network 104 using the single MAC address 112. An example of this approach is described in FIG. 4.

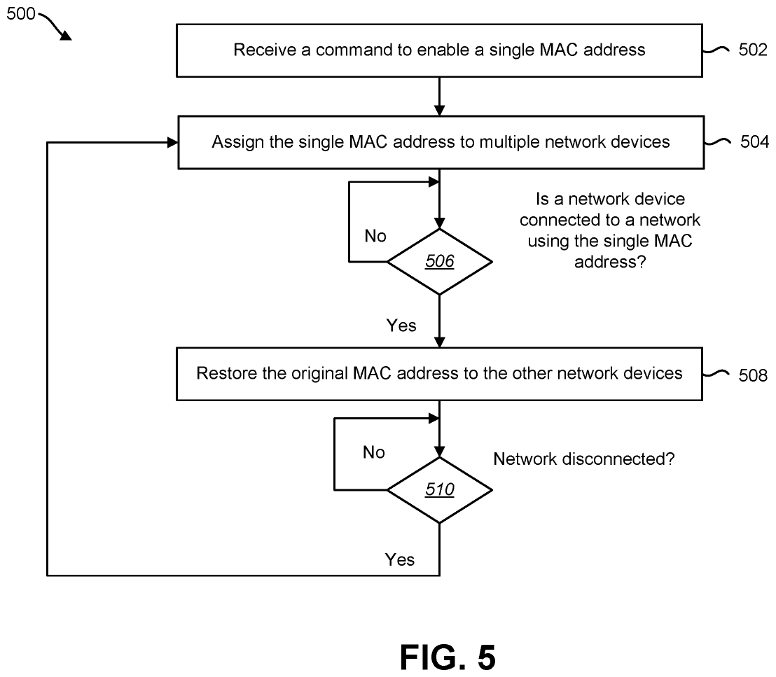

In other examples, the processor 110 may determine that a network device (e.g., the first network device 106) is connected to the network 104 using the single MAC address 112. The processor 110 may then restore the original MAC address of the other network devices (e.g., the second network device 108). In this approach, the other network devices (e.g., the second network device 108) may remain active when one network device (e.g., the first network device 106) is connected to the network 104. Some examples of this approach are described in FIG. 5-7.

As used herein, the term “disable” refers to the processor 110 causing a network device (e.g., the first network device 106 and/or second network device 108) to be unable to connect to the network 104. Also, as used herein, the term “enable” refers to the processor 110 causing a network device (e.g., the first network device 106 and/or second network device 108) to be able to connect to the network 104.

In some examples, the processor 110 may disable a network device at an OS layer. For example, the processor 110 may change settings within the OS to deactivate a network device or block the network device from connecting to the network 104. In this example, the processor 110 may enable the network device by changing settings within the OS to allow the network device to connect to the network 104.

In other examples, the processor 110 may disable a network device at the hardware layer. For example, the processor 110 may send commands to the network device to deactivate the network device. In some examples, the processor 110 may send a command to turn off power to the network device. It should be noted that this approach may save power (e.g., battery) on the electronic device 102 while the network device is disabled (e.g., powered down). In this example, the processor 110 may enable the network device by changing settings within the hardware layer to allow the network device to connect to the network 104. For example, the processor 110 may enable the network device by sending a command to turn on power to the network device.

In yet other examples, the processor 110 may disable a network device at a physical layer of the network device. For example, the processor 110 may change settings within the hardware of the network device to deactivate a transmitter and receiver of the network device. This may prevent the network device from communicating on the network 104 without shutting down the network device. In this example, the processor 110 may enable the network device by changing settings within the physical layer of the network device to allow the network device to connect to the network 104. For example, the processor 110 may enable the network device by activating the transmitter and receiver of the network device.

In some examples, once a network device (e.g., the first network device 106) is disconnected from the network 104 another network device (e.g., the second network device 108) may connect to the network 104 using the single MAC address 112. Therefore, the first network device 106 and the second network device 108 may be registered on the network 104 using the single MAC address 112 when connected to the network 104. In other words, because the first network device 106 and the second network device 108 share the single MAC address 112, the first network device 106 and the second network device 108 may appear as the same network device to the network 104. Because the processor 110 ensures that one network device is connected to the network 104 at a time, the first network device 106 and the second network device 108 may be registered on the network 104 using the single MAC address 112.

In some examples, the first network device 106 and the second network device 108 share a single IP address based on the single MAC address 112 when connected to the network 104. In some examples, the network 104 may assign an IP address lease using a MAC address of the network device. Because the first network device 106 and the second network device 108 share a single MAC address 112, the network 104 may assign a single IP address to the first network device 106 and the second network device 108.

The examples for a single MAC address 112 described herein may allow an IT administrator to manage a single MAC address 112 for each electronic device 102, thus reducing the complexity associated with multiple MAC addresses on a single electronic device 102. Also, IP address leases may be less burdensome to manage, because one IP address is associated with each electronic device 102 based on the single MAC address 112.

Furthermore, an electronic device 102 may switch between different network devices (Ethernet, Wi-Fi, Dock, etc.). However, the IP address lease will provide a single IP address for the different network devices. By using a single IP address for different network devices, complexity may be reduced for applications on the electronic device 102 and the network 104 to manage the transition.

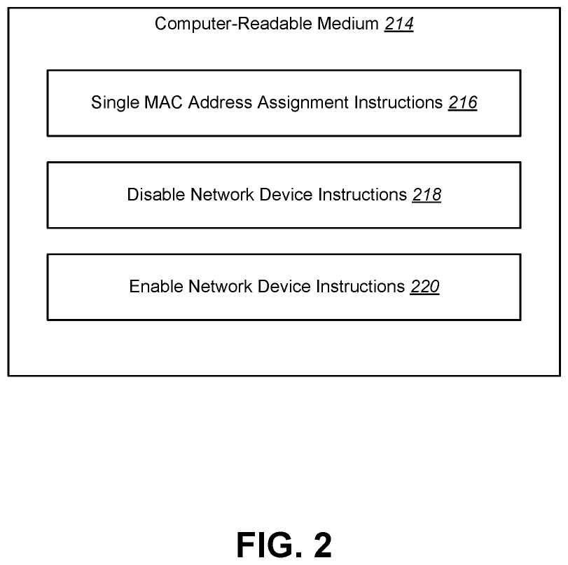

FIG. 2 is a block diagram illustrating an example of a computer-readable medium 214 encoded with instructions to use a single MAC address for network devices in an electronic device. The computer-readable medium 214 may be a non-transitory, tangible computer-readable medium 214. The computer-readable medium 214 may be, for example, RAM, EEPROM, a storage device, an optical disc, and the like. In some examples, the computer-readable medium 214 may be volatile and/or non-volatile memory, such as DRAM, EEPROM, MRAM, PCRAM, memristor, flash memory, and the like. In some examples, the computer-readable medium 214 described in FIG. 2 may be an example of memory for an electronic device 102 described in FIG. 1. In some examples, code (e.g., data and/or executable code or instructions) of the computer-readable medium 214 may be transferred and/or loaded to memory or memories of the electronic device 102.

The computer-readable medium 214 may include code (e.g., data and/or executable code or instructions). For example, the computer-readable medium 214 may include single MAC address assignment instructions 216, disable network device instructions 218, and enable network device instructions 220.

In some examples, the single MAC address assignment instructions 216 may be instructions that when executed cause the processor of the electronic device to assign a single media access control (MAC) address to a first network device and a second network device. For example, the processor may override the original (e.g., factory programmed) MAC address of the first network device and/or the second network device such that the network devices have the same MAC address. In some examples, this may be accomplished as described in FIG. 1.

In some examples, the disable network device instructions 218 may be instructions that when executed cause the processor of the electronic device to disable the first network device and the second network device from connecting to a network. For example, the processor may disable the network devices by making changes at the OS layer, hardware layer and/or physical layer of the network devices to block the first network device and the second network device from connecting to the network. In some examples, this may be accomplished as described in FIG. 1.

In some examples, the enable network device instructions 220 may cause the processor to enable the first network device for a period of time to determine if the first network device is connected to the network using the single MAC address. In some examples, the processor may enable the first network device by making changes at the OS layer, hardware layer and/or physical layer of the network devices to allow the first network device and the second network device to connect to the network. In some examples, the period of time may be a particular amount of time to allow the first network device to connect to the network. In some examples, the period of time may be stored in the memory of the electronic device. In some examples, this may be accomplished as described in FIG. 1.

In some examples, the processor may disable the first network device in response to determining that the first network device has been enabled for the period of time without connecting to the network. The processor may then enable the second network device for the period of time in response to disabling the first network device. If the second network device does not connect to the network within the period of time, the processor may disable the second network device. The processor may then repeat this process of sequentially enabling and disabling the first network device and the second network device until a network device is connected to the network. An example of this approach for providing a single MAC address is described in FIG. 5.

FIG. 3 is a flow diagram illustrating an example method 300 for using a single MAC address 112 for network devices. The method 300 and/or an element or elements of the method 300 may be implemented by the electronic device 102 of FIG. 1. The method 300 may be described with reference to the electronic device 102.

At 302, the electronic device 102 may assign a single MAC address 112 to multiple network devices (e.g., the first network device 106 and the second network device 108). For example, the electronic device 102 (e.g., processor 110) may receive a command (e.g., via a user BIOS setting or OS setting) to enable the single MAC address 112. The electronic device 102 may then program the MAC address of the first network device 106 and/or the second network device 108 to override the original (e.g., factory programmed) MAC address of the first network device 106 and/or the second network device 108.

In some examples, the electronic device 102 may generate the single MAC address 112 assigned to the first network device 106 and the second network device 108. In other examples, the electronic device 102 may apply a host MAC address (e.g., system MAC address) to the first network device 106 and the second network device 108. In yet other examples, the electronic device 102 may select the single MAC address 112 from an original (e.g., factory programmed) MAC address for the first network device 106 or second network device 108.

At 304, the electronic device 102 may determine whether a network device is connected to the network 104 using the single MAC address 112. For example, the electronic device 102 may determine whether the first network device 106 or the second network device 108 is connected to the network 104 using the single MAC address 112. If the electronic device 102 does not detect that a network device is connected to the network 104, then the electronic device 102 may continue to monitor the network devices, at 304.

If the electronic device 102 determines that a network device (e.g., the first network device 106) is connected to the network 104 using the single MAC address 112, then the electronic device 102 may disable the other network devices (e.g., the second network device 108), at 306. The electronic device 102 may monitor the connected network device (e.g., the first network device 106) at 308 to determine whether the network device is disconnected from the network 104. If the electronic device 102 determines that the network device remains connected to the network 104, then the electronic device 102 may continue to monitor the network connection, at 308.

If the electronic device 102 determines that the network device is disconnected from the network 104, then the electronic device 102 may enable all network devices (e.g., the first network device 106 and the second network device 108) at 310. The electronic device 102 may then monitor the network devices, at 304, to determine whether a network device is connected to the network 104 using the single MAC address 112.

FIG. 4 is a flow diagram illustrating yet another example method 400 for using a single MAC address 112 for network devices. The method 400 and/or an element or elements of the method 400 may be implemented by the electronic device 102 of FIG. 1. The method 400 may be described with reference to the electronic device 102.

At 402, the electronic device 102 may assign a single MAC address 112 to multiple network devices (e.g., the first network device 106 and the second network device 108). This may be accomplished as described in FIG. 3.

At 404, the electronic device 102 may disable the multiple network devices. For example, the electronic device 102 may disable the first network device 106 and the second network device 108 from connecting to a network 104.

At 406, the electronic device 102 may enable a particular network device. For example, the electronic device 102 may enable the first network device 106 to be able to connect to the network 104 using the single MAC address 112.

At 408, the electronic device 102 may determine whether the particular network device (e.g., the first network device 106) is connected to the network 104 within a period of time. For example, the electronic device 102 may determine whether the first network device 106 is connected to the network 104 using the single MAC address 112.

If the electronic device 102 determines that the particular network device (e.g., first network device 106) is not connected to the network 104 before the period of time expires, then, at 410, the electronic device 102 may disable the particular network device (e.g., the first network device 106) and may select another network device (e.g., the second network device 108). The electronic device 102 may then enable the newly selected particular network device (e.g., the second network device 108), at 406. For example, the electronic device 102 (e.g., the processor 110) may enable the second network device 108 for the period of time in response to disabling the first network device 106, at 406.

This process may continue until a network device is connected to the network 104. For example, if the electronic device 102 determines, at 408, that the second network device 108 has been enabled for the period of time without connecting to the network 104, then the electronic device 102 may disable the second network device 108, at 410. The electronic device 102 may then enable the first network device 106 again for the period of time, at 406.

If the electronic device 102 determines, at 408, that the particular network device (e.g., first network device 106) is connected to the network 104 within the period of time, then, at 412, the electronic device 102 may monitor the connected network device (e.g., the first network device 106) to determine whether the network device is disconnected from the network 104. If the electronic device 102 determines that the network device remains connected to the network 104, then the electronic device 102 may continue to monitor the network connection, at 412.

If the electronic device 102 determines that the network device is disconnected from the network 104, then the electronic device 102 may again disable the multiple network devices (e.g., the first network device 106 and the second network device 108) at 404. The electronic device 102 may then sequentially enable network devices, at 406, to determine whether a network device is connected to the network 104 using the single MAC address 112.

FIG. 5 is a flow diagram illustrating another example method 500 for using a single MAC address 112 for network devices. The method 500 and/or an element or elements of the method 500 may be implemented by the electronic device 102 of FIG. 1. The method 500 may be described with reference to the electronic device 102.

At 502, the electronic device 102 may receive a command to enable the single MAC address 112. For example, the command may be received from the BIOS of the electronic device 102 or the OS of the electronic device 102. In some examples, the command may be received in response to a user selection to enable the single MAC address 112.

At 504, the electronic device 102 may assign the single MAC address 112 to multiple network devices (e.g., the first network device 106 and the second network device 108). This may be accomplished as described in FIG. 3. It should be noted that the single MAC address 112 may override the original MAC addresses of the first network device 106 and/or the second network device 108.

At 506, the electronic device 102 may determine whether a network device is connected to the network 104 using the single MAC address 112. For example, the electronic device 102 may determine whether the first network device 106 or the second network device 108 is connected to the network 104 using the single MAC address 112. If the electronic device 102 does not detect that a network device is connected to the network 104, then the electronic device 102 may continue to monitor the network devices, at 506.

If the electronic device 102 determines that a network device (e.g., the first network device 106) is connected to the network 104 using the single MAC address 112, then the electronic device 102 may restore the original MAC address to the other network devices (e.g., the second network device 108), at 508. For example, restoring the original MAC address may include changing the MAC address of the second network device 108 from the single MAC address 112 back to the original (e.g., factory programmed) MAC address.

In some examples, the second network device 108 may remain active with its original MAC address while the first network device 106 is connected to the network 104 using the single MAC address 112. In some examples, the second network device 108 may also connect to the network 104 based on the original MAC address restored to the second network device 108 while the first network device 106 is connected to the network 104 using the single MAC address 112.

The electronic device 102 may monitor the connected network device (e.g., the first network device 106) at 510 to determine whether the network device is disconnected from the network 104. If the electronic device 102 determines that the network device remains connected to the network 104, then the electronic device 102 may continue to monitor the network connection, at 510.

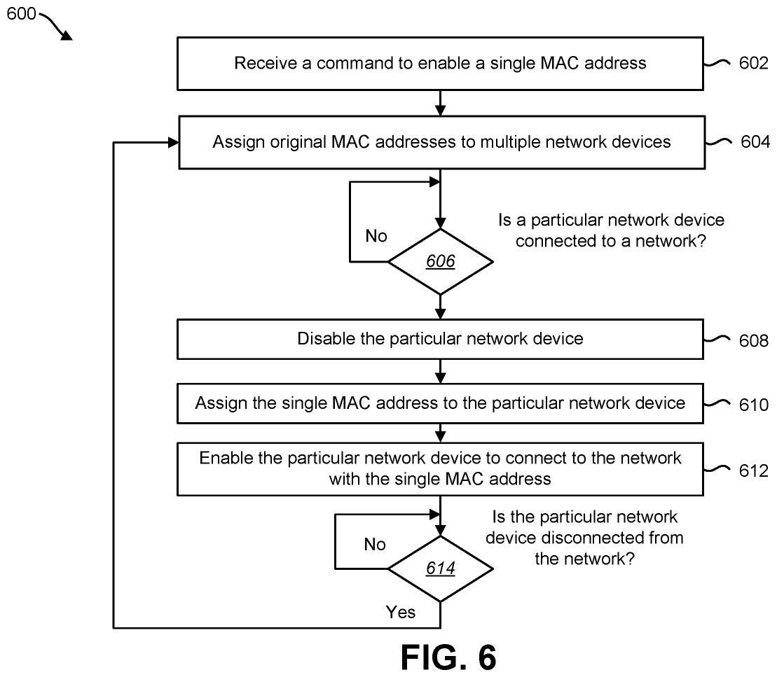

FIG. 6 is a flow diagram illustrating another example method 600 for using a single MAC address 112 for network devices. The method 600 and/or an element or elements of the method 600 may be implemented by the electronic device 102 of FIG. 1. The method 600 may be described with reference to the electronic device 102.

At 602, the electronic device 102 may receive a command to enable the single MAC address 112. This may be accomplished as described in FIG. 5.

At 604, the electronic device 102 may assign the original MAC addresses to multiple network devices (e.g., the first network device 106 and the second network device 108). For example, the original MAC address may be the factory programmed MAC address associated with a given network device.

At 606, the electronic device 102 may determine whether a particular network device is connected to the network 104 using the original MAC address. For example, the electronic device 102 may determine whether the first network device 106 is connected to the network 104 using its original MAC address. If the electronic device 102 does not detect that a network device is connected to the network 104, then the electronic device 102 may continue to monitor the network devices, at 606.

If the electronic device 102 determines that a particular network device (e.g., the first network device 106) is connected to the network 104 using the original MAC address, then the electronic device 102 may disable the particular network device, at 608. The electronic device 102 may assign a single MAC address 112 to the particular network device (e.g., the first network device 106), at 610. For example, the single MAC address 112 may override the original (e.g., factory programmed) MAC address. At 612, the electronic device 102 may then enable the particular network device (e.g., the first network device 106) to connect to the network 104 with the single MAC address 112.

The electronic device 102 may monitor the connected network device (e.g., the first network device 106) at 614 to determine whether the network device is disconnected from the network 104. If the electronic device 102 determines that the network device remains connected to the network 104, then the electronic device 102 may continue to monitor the network connection, at 614.

If, at 614, the electronic device 102 determines that the particular network device (e.g., the first network device 106) is disconnected from the network 104, then the electronic device 102 may again assign the original MAC address to the multiple network devices (e.g., the first network device 106 and the second network device 108) at 604. The electronic device 102 may then monitor the network devices, at 606, to determine whether a network device is connected to the network 104 using the original MAC address.

It should be noted that in the example of FIG. 6, there is no possibility for two network devices to connect to the network 104 using the same MAC address (e.g., the single MAC address 112). Furthermore, with this example, CPU cycles for switching, monitoring, etc. may be less than with a round robin approach. Instead, the example of FIG. 6 is an interrupt-based approach.

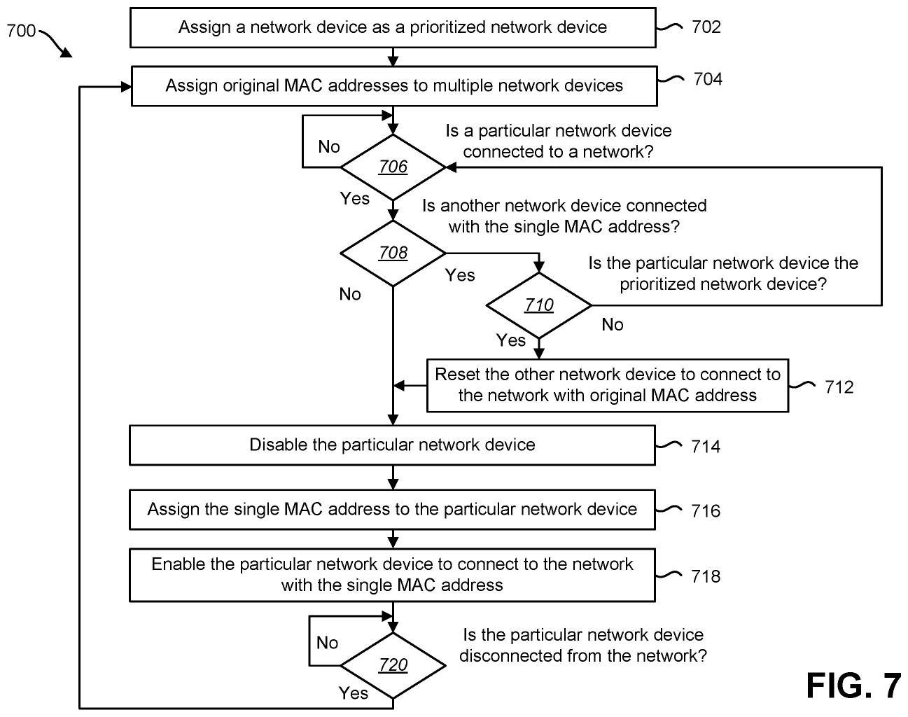

FIG. 7 is a flow diagram illustrating yet another example method 700 for using a single MAC address 112 for network devices. The method 700 and/or an element or elements of the method 700 may be implemented by the electronic device 102 of FIG. 1. The method 700 may be described with reference to the electronic device 102.

At 702, the electronic device 102 may assign a network device (e.g., the first network device 106) as a prioritized network device. As used herein, the prioritized network device may be given priority for connecting to the network 104 using the single MAC address 112. In some examples, the prioritized network device may be assigned the single MAC address 112 in response to being designated as the prioritized network device. In other examples (e.g., as illustrated in FIG. 7), the electronic device 102 may assign the single MAC address 112 to the prioritized network device in response to the prioritized network device connecting to the network 104.

In some examples, the prioritized network device may be chosen based on device history. For example, the last known network device to connect to the network 104 may be assigned the prioritized network device. In another example, the most frequently used network device may be assigned the prioritized network device.

In some examples, the prioritized network device may be chosen by the user. For example, a user may prefer to give a wired Ethernet priority for the single MAC address 112.

At 704, the electronic device 102 may assign the original MAC addresses to multiple network devices (e.g., a first network device 106 and a second network device 108). For example, the original MAC addresses may be factory programmed MAC address associated with a given network device. The electronic device 102 may assign a first original MAC address to the first network device 106 and a second original MAC address to the second network device 108.

At 706, the electronic device 102 may determine whether a particular network device is connected to the network 104 using the original MAC address. For example, the electronic device 102 may determine whether the first network device 106 is connected to the network 104 using its original MAC address. If the electronic device 102 does not detect that a network device is connected to the network 104, then the electronic device 102 may continue to monitor the network devices, at 706.

If the electronic device 102 determines, at 706, that a particular network device (e.g., the first network device 106) is connected to the network 104 using the original MAC address, then the electronic device 102 may determine, at 708, whether another network device (e.g., the second network device 108) is currently connected to the network 104 with the single MAC address 112.

If no network device is connected to the network 104 using the single MAC address 112, then the electronic device 102 may disable the particular network device, at 714. The electronic device 102 may assign a single MAC address 112 to the particular network device (e.g., the first network device 106), at 716. At 718, the electronic device 102 may then enable the particular network device (e.g., the first network device 106) to connect to the network 104 with the single MAC address 112.

If, at 708, the electronic device 102 determines that another network device is connected to the network 104 using the single MAC address 112, then the electronic device 102 may determine whether the particular network device is the prioritized network device. If the electronic device 102 determines that the particular network device is not the prioritized network device, then the electronic device 102 may continue to monitor whether another network device is connected to the network 104, at 706.

If the electronic device 102 determines, at 710, that the particular network device is the prioritized network device, then the electronic device 102 may reset the other network device (e.g., the second network device 108) with the original MAC address, at 712. For example, before assigning the single MAC address 112 to the first network device 106, the electronic device 102 may reset the second network device 108 with the original MAC address. Resetting the second network device 108 may include disabling the second network device 108, assigning the original MAC address to the second network device 108 and enabling the second network device 108 to connect to the network 104 using the original MAC address.

Upon resetting the other network device, at 712, the electronic device 102 may disable the particular network device, at 714, assign the single MAC address 112 to the particular network device, at 716 and enable the particular network device to connect to the network 104 with the single MAC address 112, at 718.

The electronic device 102 may monitor the connected network device (e.g., the first network device 106), at 720, to determine whether the particular network device is disconnected from the network 104. If the electronic device 102 determines that the particular network device remains connected to the network 104, then the electronic device 102 may continue to monitor the network connection, at 720.

If the electronic device 102 determines that the particular network device is disconnected from the network 104, then the electronic device 102 may again assign the original MAC address to the multiple network devices (e.g., the first network device 106 and the second network device 108), at 704. The electronic device 102 may then monitor the network devices, at 706, to determine whether a network device is connected to the network 104.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operations, functions, aspects, or elements of the examples described herein may be omitted or combined.

1. An electronic device, comprising:
a first network device;
a second network device; and
a processor to:
assign a single media access control (MAC) address to the first network device and the second network device;
determine that the first network device is connected to a network using the single MAC address; and
disable the second network device in response to determining that the first network device is connected to the network.

2. The electronic device of claim 1, wherein the processor is to generate the single MAC address assigned to the first network device and the second network device.

3. The electronic device of claim 1, wherein the single MAC address differs from a factory programmed MAC address for the first network device or the second network device.

4. The electronic device of claim 1, wherein the processor is to select the single MAC address from one of a factory programmed MAC address for the first network device or a factory programmed MAC address the second network device.

5. The electronic device of claim 1, wherein the first network device and the second network device are registered on the network using the single MAC address when connected to the network.

6. The electronic device of claim 1, wherein the first network device and the second network device share a single IP address based on the single MAC address when connected to the network.

7. The electronic device of claim 1, wherein the processor is to enable the first network device for a period of time to determine if the first network device is connected to the network using the single MAC address.

8. The electronic device of claim 7, wherein the processor is to:
disable the first network device in response to determining that the first network device has been enabled for the period of time without connecting to the network;
enable the second network device for the period of time in response to disabling the first network device; and
disable the second network device in response to determining that the second network device has been enabled for the period of time without connecting to the network.

9. An electronic device, comprising:
a first network device;
a second network device; and
a processor to:
assign a single media access control (MAC) address to the first network device and the second network device, the single MAC address overriding original MAC addresses of the first network device and the second network device;
determine that the first network device is connected to a network using the single MAC address; and
restore the original MAC address to the second network device in response to determining that the first network device is connected to the network.

10. The electronic device of claim 9, wherein the processor is to assign the single MAC address to the first network device and the second network device in response to determining that the first network device is disconnected from the network.

11. The electronic device of claim 9, wherein the second network device is to connect to the network based on the original MAC address restored to the second network device.

12. The electronic device of claim 9, wherein the processor is to assign the single MAC address to the first network device and the second network device in response to receiving a command to enable the single MAC address.

13. A non-transitory tangible computer-readable medium comprising instructions when executed cause a processor of an electronic device to:
assign a first original media access control (MAC) address to a first network device and a second original MAC address to a second network device;
determine that the first network device is connected to a network using the original MAC address; and
assign a single MAC address to the first network device in response to determining that the first network device is connected to the network using the original MAC address, the single MAC address overriding the original MAC address of the first network device.

14. The non-transitory tangible computer-readable medium of claim 13, wherein the processor is to:
disable the first network device in response to determining that the first network device is connected to the network using the original MAC address; and
enable the first network to connect to the network using the single MAC address in response to assigning the single MAC address to the first network device.

15. The non-transitory tangible computer-readable medium of claim 13, wherein the processor is to:
assign the first network device as a prioritized network device;
determine that the second network device is connected to the network with the single MAC address; and
reset the second network device with the original MAC address before assigning the single MAC address to the first network device.
